(19) United States
(12) Patent Application Publication
(10) Pub. No.: US 2017/0310535 A1
(43) Pub. Date: Oct. 26, 2017

(54) DIAGNOSIS METHOD AND DIAGNOSTIC DEVICE FOR A NETWORK

(71) Applicant: SIEMENS AKTIENGESELLSCHAFT, München (DE)

(72) Inventor: Tobias Siegel, Nürnberg (DE)

(73) Assignee: SIEMENS AKTIENGESELLSCHAFT, München (DE)

(21) Appl. No.: 15/491,510

(22) Filed: Apr. 19, 2017

(30) Foreign Application Priority Data
Apr. 20, 2016 (DE) 10 2016 206 707.9

(51) Int. Cl. H04L 12/24; H04L 12/26

(52) U.S. Cl. CPC H04L 41/064; H04L 43/0817

(57) ABSTRACT

A diagnosis method and a diagnostic device for a network are disclosed. The network includes at least one network device. The network device is connected to the network. The network device has an operating hours counter, which outputs a time information relating to an operating time. The network device is re-connected to the network following a connection failure with the network at a connection failure instant. The method includes determining an operating time of an operating hours counter configured in a network device of the network to output a time information relating to the operating time, determining a connection failure time of the network device to the network at a connection failure instant until connection to the network is established and determining a reason for the connection failure using a comparison between the operating time and the connection failure time.

### CROSS-REFERENCES TO RELATED APPLICATIONS

This application claims the priority of German Patent Application, Serial No. 102016206707.9, filed Apr. 20, 2016, pursuant to 35 U.S.C. 119(a)-(d), the content of which is incorporated herein by reference in its entirety as if fully set forth herein.

### BACKGROUND OF THE INVENTION

The present invention relates to a diagnosis method and diagnostic device for a network.

The following discussion of related art is provided to assist the reader in understanding the advantages of the invention, and is not to be construed as an admission that this related art is prior art to this invention.

Communications networks are increasingly being used to scan, control and regulate complex technical systems. A standard network environment, which is popular, is based on the Ethernet protocol. The use of Ethernet infrastructures has the advantage that standardized network devices and methods can be used.

A considerable loss of income results for the respective network operator if, defectively, connections cannot be established when requested by users. Such failures conventionally result due to faults in the network or network device itself, for example couplers, network control points, signal transmission points or similar elements.

Current monitoring methods find faults and isolate them with the aid of maintenance operations by simply noting merely the occurrence of a fault and identifying the faulty network element. In addition to carrying out this kind of fault finding and isolation, with actual connection errors test connections can be initiated to trigger an additional fault analysis. The network element then has to be queried, for example.

An accurate analysis in respect of the type and reason for the fault—the underlying cause of the fault—cannot be obtained during a relatively long period therefore.

Networks to IEEE802 are based on active switching technology, i.e. received telegrams are read in and actively re-generated so as to be identical on the port for transmission. Different mechanisms are used for switching, e.g. Cut-Through, Store and forward and more. Switching is only possible if the integrated switch of the network devices is supplied with power.

No distinction can be made as to whether the faults lie on the network itself or on the device due to the system properties of the Ethernet to IEEE802. The faults mentioned above are reported by an interruption in communication and device failure.

Previously, with a faulty connection of the network device to the network, a manual visual inspection of the cabling or a manual device-specific inspection of the devices was carried out to fix the fault.

It would therefore be desirable and advantageous to provide an improved diagnosis method and diagnostic device to obviate prior art shortcomings and to enable indication of a cause of reported faults in a network in a simple manner.

### SUMMARY OF THE INVENTION

According to one aspect of the present invention, a diagnosis method for a network includes determining an operating time of an operating hours counter configured in a network device of the network to output a time information relating to the operating time; determining a connection failure time of the network device to the network at a connection failure instant until connection to the network is established; and determining a reason for the connection failure using a comparison between the operating time and the connection failure time.

According to another aspect of the present invention, a diagnostic device for a network which includes at least one network device connected to the network and having an operating hours counter to output a time information relating to an operating time, the diagnostic device configured to: determine an operating time of an operating hours counter configured in a network device of the network to output a time information relating to the operating time; determine a connection failure time of the network device to the network at a connection failure instant until connection to the network is established; and determine a reason for the connection failure using a comparison between the operating time and the connection failure time.

An operating hours counter (operating time counter) is a measuring device which is provided to add up the time during which a device, for example an electronic unit, is in operation. For example, the duration in hours that a technical plant can remain in operation between two services without serious damage, such as the failure of components, assemblies or subsystems due to abrasion or wear having to be reckoned with, is conventionally indicated as the operating hours. The operating time should therefore be seen as the time since the last startup of the device.

In accordance with the present invention, the diagnosis method and the diagnostic device are based on the restart analysis of network devices. A detailed statement about the cause of the fault can be determined by manual or automatic querying of the operating time of the operating hours counter and connection failure time and the subsequent comparison. In this way, existing information can be used, for example in Ethernet-based networks to IEEE802, to enable improved diagnosis.

According to another advantageous feature of the present invention, a query time of the operating hours counter, a connection failure instant, and a first differential value can be determined as the connection failure time by forming a difference between the query time of the operating hours counter and the connection failure instant. These values can be determined, e.g. by standard mechanisms having the network management protocol SNMP, Simple Network Management Protocol to RFC 1157 and RFC 3410.

According to another advantageous feature of the present invention, the comparison can be rated with a diagnosis value TRUE if the operating time is less than or equal to the connection failure time, and can be rated with a diagnosis value FALSE if the operating time is greater than the connection failure time. This may involve a restart of the network device and/or a power failure of the network device. With a diagnosis value FALSE, the reason for connection failure can therefore be a network error.

According to another advantageous feature of the present invention, the comparison can be formed by determining a second differential value. Advantageously, the second differential value can be formed by subtraction of the operating time from the first differential value. With a zero value or negative second differential value, the reason for connection failure can be the network device. The reason for connection failure can have been effected e.g. by a restart of the network device and/or a power failure of the network device.

According to another advantageous feature of the present invention, the reason for the connection failure can be a network error when the second differential value is positive.

According to another advantageous feature of the present invention, the query time of the operating hours counter can be a current time of the network device reporting the error. This can be easily determined.

According to another advantageous feature of the present invention, the connection failure time can be signaled by the network device reporting the error. The network device reporting the error can hereby also be designed as a software tool.

### BRIEF DESCRIPTION OF THE DRAWING

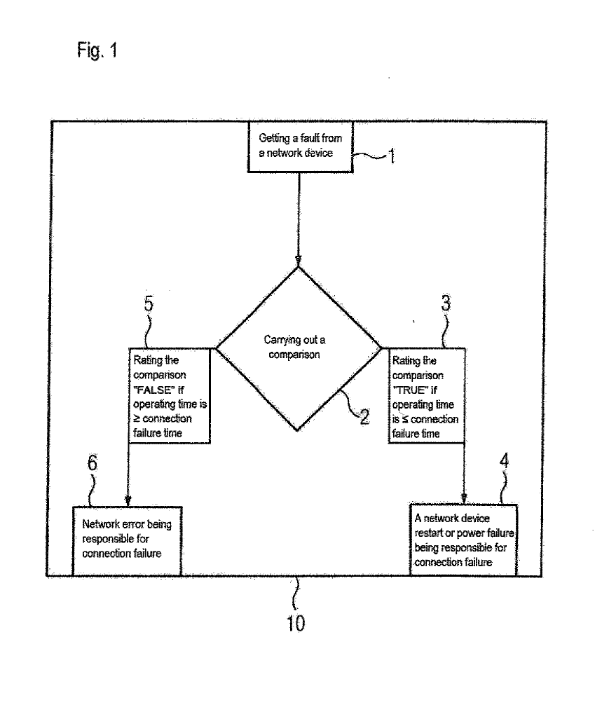

Other features and advantages of the present invention will be more readily apparent upon reading the following description of currently preferred exemplified embodiments of the invention with reference to the accompanying drawing, in which the sole FIG. 1 schematically shows a flow diagram for executing a diagnosis method in an diagnostic device in accordance with the present invention.

### DETAILED DESCRIPTION OF PREFERRED EMBODIMENTS

The depicted embodiment is to be understood as illustrative of the invention and not as limiting in any way. It should also be understood that the figure may not necessarily be to scale. In certain instances, details which are not necessary for an understanding of the present invention or which render other details difficult to perceive may have been omitted.

Faults, such as network errors or network device failure, are reported by an interruption in communication. Previously the cause has been determined by a manual visual inspection of the cabling or by a manual device-specific inspection of the devices.

According to the invention this problem is now solved by a restart analysis of the network device. Once the network device is available again in terms of communications, i.e. is visible in the network, the operating hours counter of the network device is checked and operating time of the operating hours counter and the connection failure time determined. Here the connection failure time is the difference from the query time of the operating hours counter less the connection failure instant. These values can be determined, e.g. by way of standard mechanisms having the network management protocol, such as SNMP, Simple Network Management Protocol according to RFC 1157 and RFC 3410.

The operating time of the operating hours counter can be determined for example by “SysUpTime” of RFC 1213. Here various RFCs define various MIB modules. Here a Management Information Base is a description containing the definitions of management information which can be used to remotely monitor, configure and control a device connected to a network.

The query time of the operating hours counter is the current time of the network device reporting the error. The network device can also be a software tool.

The connection failure instant i.e. the down-time of the network device, is signaled by the device reporting the error or software tool.

A query is then started:
If the “operating time” is greater than the “connection failure time”, the cause of failure is a network error.
If the “operating time” is less than or equal to the “down-time of the device”, the cause of failure is a network device restart/network device failure or a power failure of the network device.

FIG. 1 accordingly gives the fault 1 from a network device to the network, i.e. the network device is no longer visible in the network. After determining the operating time and the connection failure time by way of the connection failure instant and the query time of the operating hours counter, a comparison 2 is then carried out and a diagnosis value determined. If the diagnosis value is TRUE 3, it can be identified e.g. by “1”. A device restart or a power failure 4 on the device can therefore be responsible for the fault 1. With a diagnosis value FALSE 5, a network error 6 would be responsible. Here the diagnosis value FALSE 5 can also be identified by a “0”. The diagnosis method described above can be arranged in a diagnostic device 10.

A clear example shall be given below.

A network device fails at 12:00 o'clock and is subsequently available again. At 12:15 the operating time of “10 min” is determined. The connection failure instant is 12:00 o'clock. The query time of the operating hours counter is 12:15 on the other hand.

The comparison

operating time<(query time of the operating hours counter—connection failure time)

is then carried out: here

10 min<12:15 o'clock−12:00 o'clock?

10 min<15 min

and a diagnosis value of “TRUE 3” determined.

This shows that the cause of the fault 1 is a device restart or power failure 4 on the device.

Existing information that is easy to determine can be used as a result of this algorithm to enable improved diagnosis in e.g. Ethernet-based networks to IEEE802.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A diagnosis method for a network, comprising:
determining an operating time of an operating hours counter configured in a network device of the network to output a time information relating to the operating time;
determining a connection failure time of the network device to the network at a connection failure instant until connection to the network is established; and
determining a reason for the connection failure using a comparison between the operating time and the connection failure time.

2. The diagnosis method of claim 1, further comprising:
determining a query time of the operating hours counter;
determining the connection failure instant; and
determining a first differential value as the connection failure time by forming a difference between the query time of the operating hours counter and the connection failure instant.

3. The diagnosis method of claim 1, further comprising:
rating the comparison with a diagnosis value TRUE, if the operating time is less than or equal to the connection failure time; and
rating the comparison with a diagnosis value FALSE, if the operating time is greater than the connection failure time.

4. The diagnosis method of claim 3, wherein the reason for the connection failure is the network device in the presence of the diagnosis value TRUE.

5. The diagnosis method of claim 4, wherein the reason for the connection failure is a restart of the network device and/or a power failure of the network device.

6. The diagnosis method of claim 3, wherein the reason for the connection failure is a network error in the presence of the diagnosis value FALSE.

7. The diagnosis method claim 2, wherein the comparison is formed by determining a second differential value.

8. The diagnosis method of claim 7, wherein the second differential value is determined by subtracting the operating time from the first differential value.

9. The diagnosis method of claim 8, wherein the reason for the connection failure is the network device in the presence of a zero value or when the second differential value is negative.

10. The diagnosis method of claim 9, wherein the reason for the connection failure is a restart of the network device and/or a power failure of the network device.

11. The diagnosis method of claim 8, wherein the reason for the connection failure is a network error when the second differential value is positive.

12. The diagnosis method of claim 2, wherein the query time of the operating hours counter is a current time of the network device reporting an error.

13. The diagnosis method of claim 12, further comprising signaling the connection failure time over the network device reporting the error.

14. A diagnostic device for a network which includes at least one network device connected to the network and having an operating hours counter to output a time information relating to an operating time, said diagnostic device configured to:
determine an operating time of an operating hours counter configured in a network device of the network to output a time information relating to the operating time;
determine a connection failure time of the network device to the network at a connection failure instant until connection to the network is established; and
determine a reason for the connection failure using a comparison between the operating time and the connection failure time.

15. The diagnostic device of claim 14, wherein the connection failure time is determined by determining a query time of the operating hours counter, determining a connection failure instant, and determining a first differential value as the connection failure time by forming a difference between the query time of the operating hours counter and the connection failure instant.

16. The diagnostic device of claim 15, wherein the comparison is rated with a diagnosis value TRUE, if the operating time is less than or equal to the first differential value, and the comparison is rated with a diagnosis value FALSE, if the operating time is greater than the first differential value.

17. The diagnostic device of claim 16, wherein the reason for the connection failure is the network device in the presence of the diagnosis value TRUE, and the reason for the connection failure is a network error in the presence of the diagnosis value FALSE.

18. The diagnostic device of claim 15, wherein the comparison is formed as a second differential value determined by subtracting the operating time from the first differential value.

19. The diagnostic device of claim 18, wherein the reason for the connection failure is the network device in the presence of a zero value or when the second differential value is negative, and the reason for the connection failure is a network error when the second differential value is positive.

20. The diagnostic device of claim 15, wherein the query time of the operating hours counter is a current time of the network device reporting an error.

21. The diagnostic device of claim 20, wherein the connection failure time is signaled over the network device reporting the error.
